(19) United States
(12) Patent Application Publication
(10) Pub. No.: US 2007/0289077 A1
(43) Pub. Date: Dec. 20, 2007

(54) Multifunction device for use with a variety of means for home cleaning- works

(76) Inventor: Wladyslaw Kaczorowski, Mineola, NY (US)

Correspondence Address: WLADYSLAW KACZOROWSKI, APT 4S, 17 RICHLEE CT, MINEOLA, NY, 11501, US

(21) Appl. No.: 11/453,381

(22) Filed: Jun. 14, 2006

(51) Int. Cl. A47L 13/144; B25G 3/00

(52) U.S. Cl. 15/119.2; 15/145; 15/230.11

(57) ABSTRACT

A device composed of a long tubular stick with a head connected with a socket by circle swing assembly. The tubular stick head front face is inclined to the tubular stick's axis about 45°. A spring slid over the socket axle's ends press tightly the socket against the tubular stick head's front face. A locking slid over one of the axle spring's end enters into the cut formed on the tool's slider and holds the tool in working position. A movable rod inside the tubular stick provided with pressing and quiding rolls, which is connected with a pilot sleeve with a pin and slid over and moves along the tubular stick together with the movable rod and with the said pin which moves along slideways formed in the wall of the tubular stick. The said rod's rolls press against the surface of the socket causing rotation of the socket with a sponge mop until reaching parallel to the tubular stick's axis position. An extension arm with a binary roll mounted at the extension arm's end, and two semicircular disks at the binary roll's ends wring out water from the sponge and semicircular disks wring out water from the sponge's edges and water is also wring out up through holes in the sponge's plate. The extension arm is connected with the movable rod by a quick-release joint. Other tools for example: a sweep broom, paint brush or roll; means to put liquid on floors; a felt polishing; a saw to cut off higher growing branches of trees or bushes, etc. The extension arm is indispensable when the sponge mop is in use, and may be taken off as well as all the movable means inside the tubular stick with one hand's motion is the same as every one of the tools, and the same using a sponge mop connected to its plate by use of a velcro which creates the possibility of structuring said invention without any movable means. The assumption of the inventor are proved by the model in scale 1:1.

### FIELD OF THE INVENTION

The present invention relates to devices for home cleaning works. It especially relates to a device allowing universal, practical and effective use for cleaning any room,” but first of all allowing to use one basic detail only and a large number of exchangeable tools for a variety of home cleaning works.

### BACKGROUND OF THE INVENTION

There exist a variety of devices for home cleaning works, but every one is almost the same. Much more similar to the present invention is a device with a standard long stick and a sponge pulled in between two rolls squeezing out water, but the oval shape of the said sponge gives no chance of cleaning any corner in any room. The most important fact is that not one of the existing devices gives the possibility of using one stick only and a great number of exchangeable tools for a variety of home cleaning works.

### SUMMARY OF THE INVENTION

The present invention gives the possibility of using one stick only, but with a number and variety of tools exchanged in seconds for a variety of home cleaning works. Another objective of the present invention is to provide a device of simple construction for much more universal utility consisting of several pieces made of commonly and available materials, such as steel, aluminium, plastic, which make the cost of production very low when mass producted. A further objective of the present invention is to provide a multifunction device for home cleaning works which is simple, easy to use and reliable, and much more effective than tools used till now. The present invention is made of a standard long tubular stick with a head of which front face is inclined to the said tubular stick's axis at about 45°. A channel shaped socket is turnably connected with the tubular stick head near the stick head's edge. Two coil springs slid over the axle's ends are constantly pressing down the socket to hold it and tightly fit, it to the stick head's front face. The socket is provided with a slideway corresponding to the tool's slider. Such solution enables exchanging a tool in a second. A locking pawl slid over one of the socket axle spring's end, and actuates by said spring, enters into a cut formed on the tool's slider blocking the tool in the working position. A push button-bolt with a spring is placed between the socket's sides. By applying pressure to the push button-bolt's head, extending outside the socket compressing the said spring, and a scarf formed on the push button, lifts the locking pawl enabling the sliding off of the tool from the socket's slideway. A movable rod with plurality pressing and guiding rolls placed inside the tubular stick is connected to a pilot sleeve by a pin. The said pilot sleeve is slid over the tubular stick, and pressed by hand, it moves together with the movable rod along the tubular stick. Pressing rolls at the rod's movable end press on the socket surface causes rotation of said socket until reaching by it a position parallel to the tubular stick axis, together with a plate with a sponge, slid over the socket's slideway. The pin connecting the pilot sleeve with the movable rod moves along a slideway formed in the tubular stick wall. An extension arm with binary rolls at its end, connected with the movable rod, moves and consequently the said binary roll while rolling over the sponge, squeezes water out of said sponge. Two semicircular disks at the binary roll ends squeeze water out of the sponge's edges. A number of holes in the plate, housing the sponge, raises the the effectiveness of squeezing as a result, water is squeeze out in every direction. The extension arm is connected with the movable rod by a quick-release joint, enabling disconnecting the extension arm from the movable rod in one second like every single tool slid over the socket's slideway. The said quick-release joint is temporarily connected with a connector which is attached to the rod and moves along a slideway formed in the tubular-slick's wall, near the tubular stick head; two bolts seated across the channel's sides, formed in the connector section protruding from the tubular stick; two wedge cuts formed in the extension arm's slat end, opposite to the end with the binary roll. Said two wedge-shaped cuts, sliding over the connector's bolts cause jamming of the extension arm on said bolts. A lip with a inclined surface being one of parts creating the blocking mechanism attached to the movable rod, overlaps the same inclined edge of a cut at the slat's end blocking the extension arm in the position. The said lip while operating is constantly under pressure of the blocking mechanism's two springs. Every slider of the present invention's set tools, except the plate with the sponge, is provided with a pin entering into hole in the tubular stick head to prevent accidental rotation of the socket with a tool being in use. The sponge is a rectangular prism which gives the possibility of cleaning perfectly every corner in a room. The extension arm with its binary roll is indispensable when a sponge mop is in use, but not necessary, when other tools are in use, and may be taken off. The said other tools are for example a sweep brush, a paint brush or roll, means to put wax on floor, a felt cloth for polishing, a device for washing windows, a saw to cut off branches of trees or bushes growing up higher from the ground etc. Two independent tubular sticks can be in use instead one only. One of them for the sponge mop and the other one for all other tools. In this case, in order to connect the extension arm with the movable rod the permanent joint is applied instead of the quick release joint. Said other tubular stick is provided with no movable details, nor any slideways, and the socket is provided with all details as is done for the device with the sponge mop. There is one difference only, one circular spring only instead of two, which is slid onto the bolt being the integral part of the socket or is attached to it. One end of said spring constantly presses down the locking pawl while the other end rests on the protrusion, which is an integral part of the socket. Said socket is attached to a slightly modified tubular stick head with application the permanent joint instead the turnable connection. To keep the basic idea of the present invention, it is possible to use a modified pin with one tubular stick and a set of a variety of tools. This modified pin is put in use connecting the pilot sleeve with the movable rod inside of the tubular stick instead of using the ordinary pin. Said modified pin allows said connection and disconnection to be done with one hand movement in one second. In effect said operation allows taking out all moveable means from the tubular stick which are dispensable using other tools excluding the use of the sponge mop. Movable means and other ones, which are indispensable using the sponge mop, give extra advantage that is extra pressure applied on the floor. If somebody prefers very light tools, it is possible to put in use the modified pin mentioned above. But the best result to achieve said effect is to use a sponge connected to its plate by using a velcro connecting the ends of two tapes which creates two sleeves slid over the sponge's plate. Said sleeves made of rubber tapes or rubber tapes together with ordinary tapes, with their sides permanently connected to the plate. In said case said sponge is coonnected to and disconnected from its plate with two hand movements (said solution is applied to the model of present invention). All movable means are dispensable and the water can be wrung out of the sponge by hand.

### BRIEF DESCRIPTION OF THE DRAWINGS

FIG. 1 represents the general view of the invention—the home cleaning device.

FIGS. 2,3 and 4 represent longitudinal cross sections of the home cleaning device.

FIG. 5 represents a side view of the home cleaning device during squeezing out water from the sponge.

FIG. 6 represents a side view of the home cleaning device.

FIG. 7 represents a tool's slider with a pin preventing a rotation of the socket.

FIG. 8 represents a longitudinal cross section of the quick-release joint of the extension arm with the movable rod and a mechanism blocking the extension arm.

FIG. 9 represents a cross section view of the socket blocking mechanism.

FIG. 10 represents a cross section view of the home cleaning device taken along line A-A in FIG. 9 which shows the push button bolt.

FIG. 11 represents a side view of the locking pawl placed inside the cut of the slider.

FIG. 12 represents a front view of the locking pawl in the direction of arrow B of FIG. 11.

FIG. 13 represents an overhead view of the locking pawl in the direction of the arrow A of FIG. 11.

FIG. 14 represents an overhead view of a tool's slider with the cut for the locking pawl.

FIG. 15 represents a front view of a tee-bar and the slider with its cut for the locking pawl.

FIG. 16 represents an overhead view of the tee-bar, the slider with the cut for the locking pawl, and a plate with numerous holes in it and the sponge.

FIG. 17 represents a cross section view of the sponge mop taken along line B-B in FIG. 16

FIG. 18 represents a longitudinal cross section of the permanent joint of the extension arm with the movable rod.

FIG. 19 represents a cross sectional view of the socket permanently attached to the tubular stick head.

FIG. 20 represents a side view of the home cleaning device with a sweep brush.

FIG. 21 represents a front view of the home cleaning device with a paint roll.

FIG. 22 represents a side view of FIG. 21.

FIG. 23 represents an overhead view of the modified pin seated in the slots of movable rod and in the slideways of the tubular stick.

FIG. 24 represents a longitudinal cross sectional view of the modified pin taken along the line C-C in FIG. 23.

FIG. 25 represents a general view of the modified pin in the direction of arrow C of FIG. 23.

### DETAILED DESCRIPTION OF THE PREFERRED EMBODIMENTS

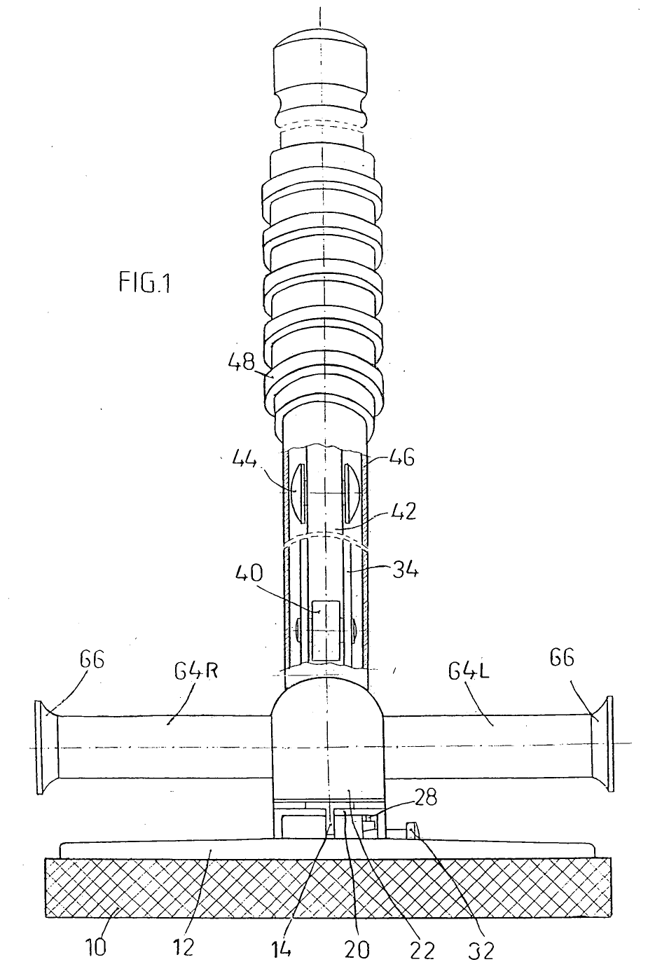

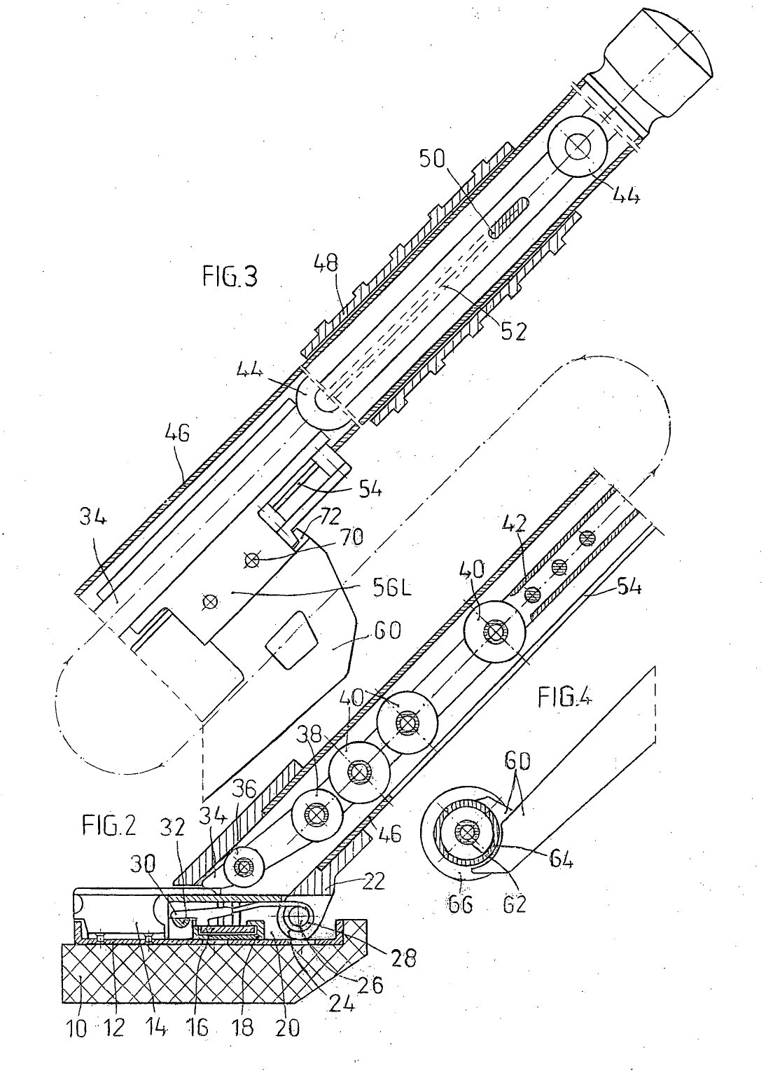

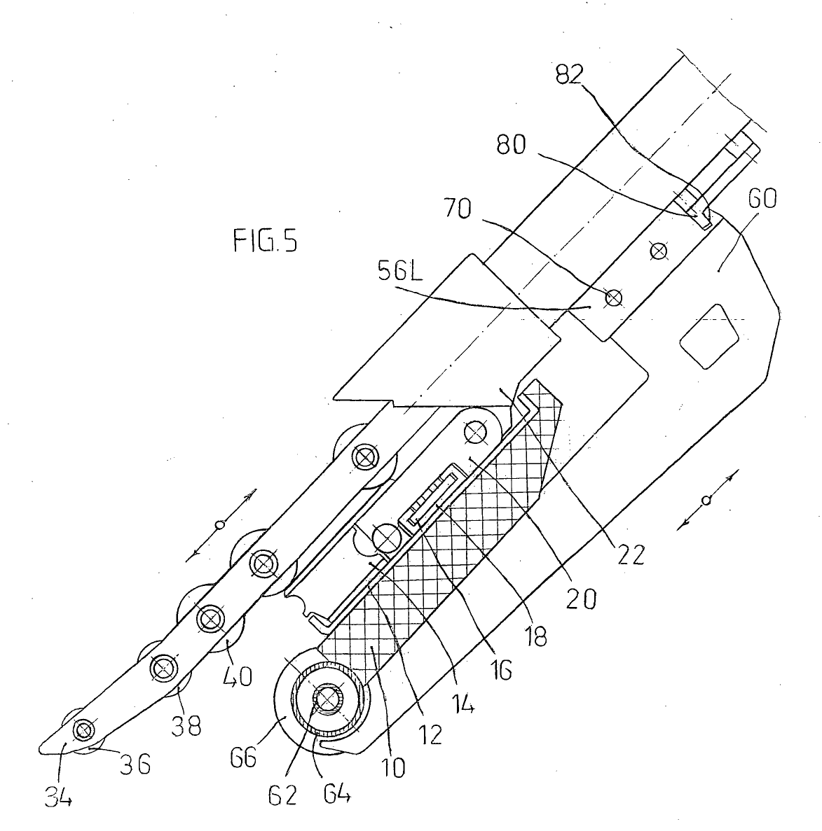

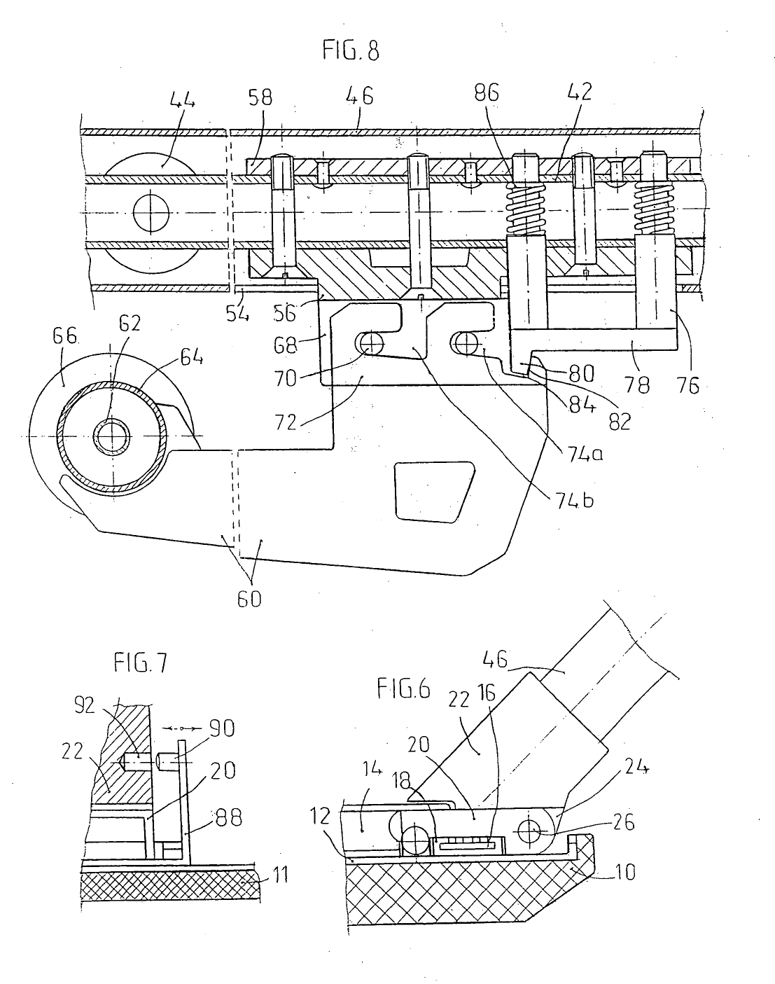

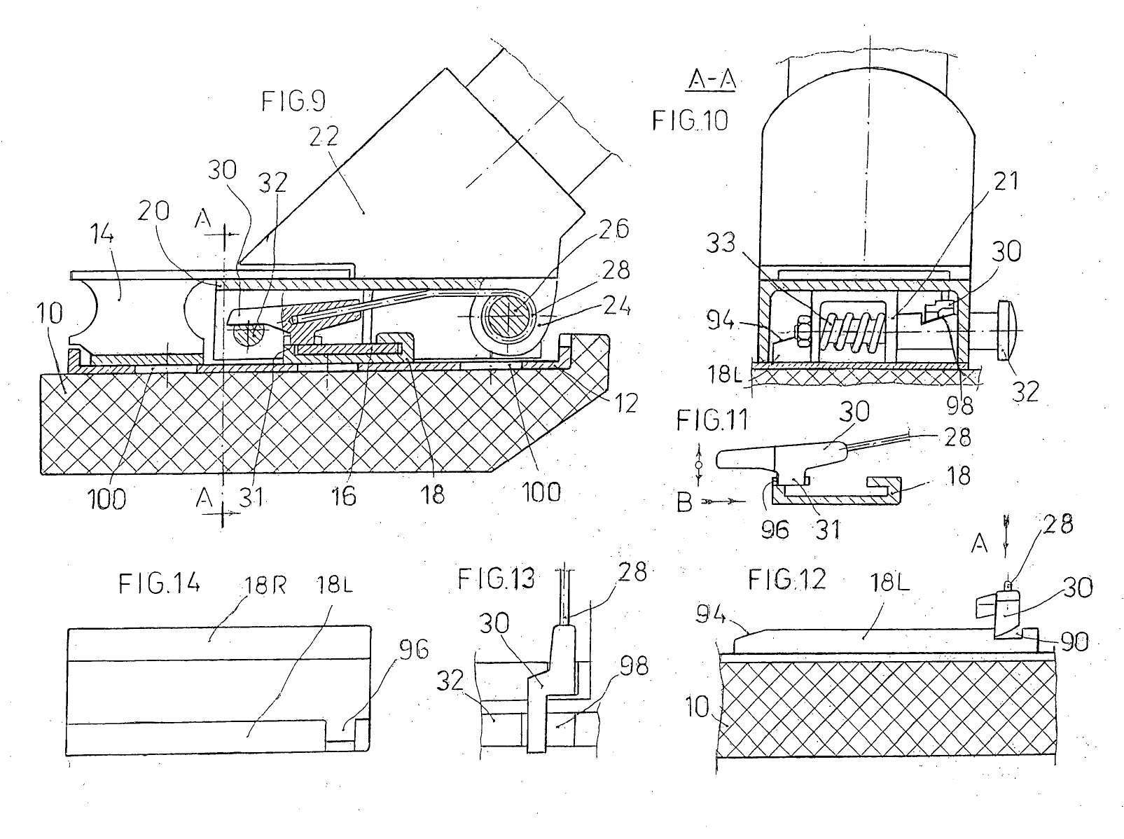

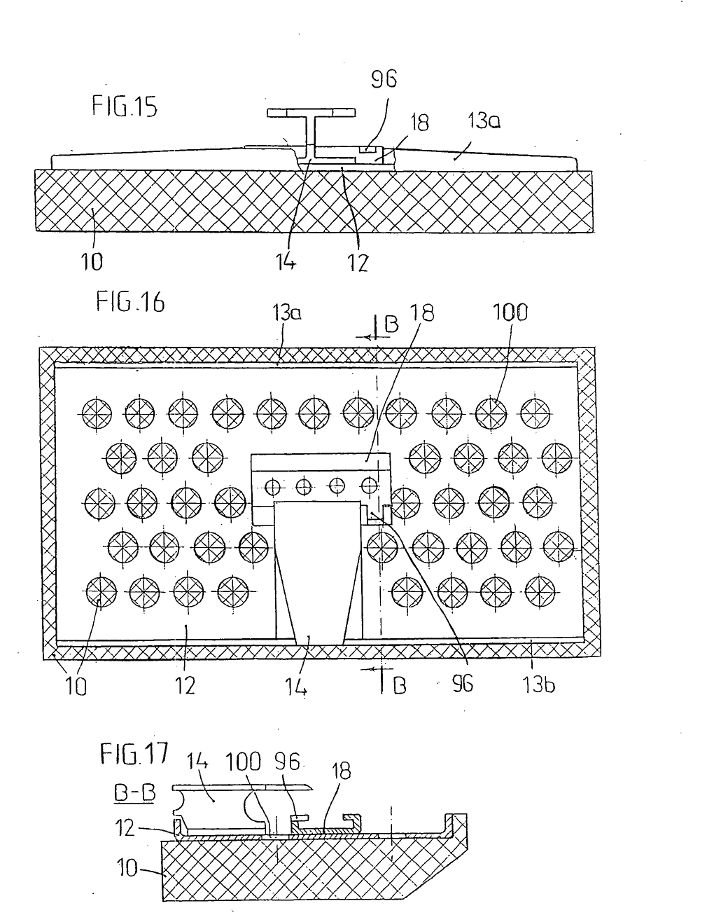

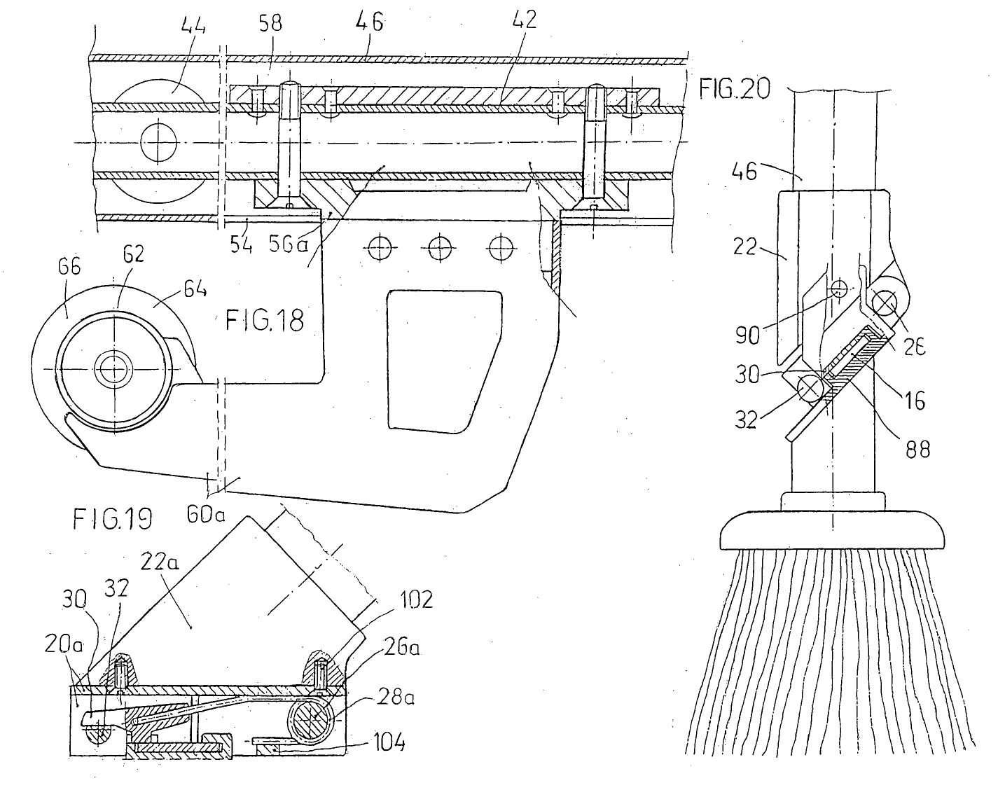

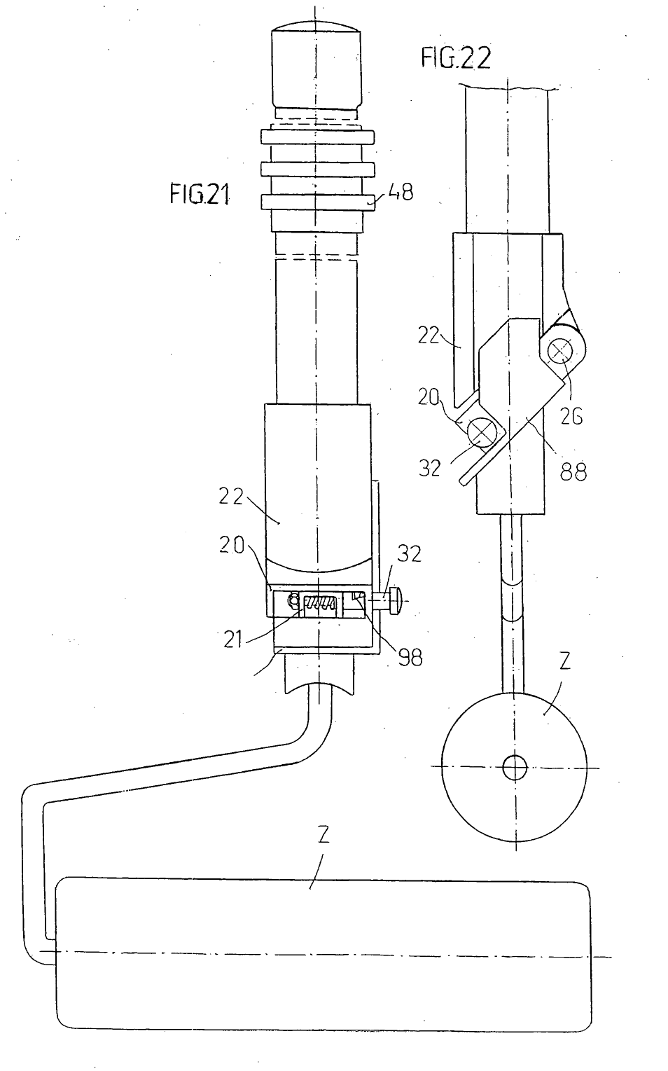

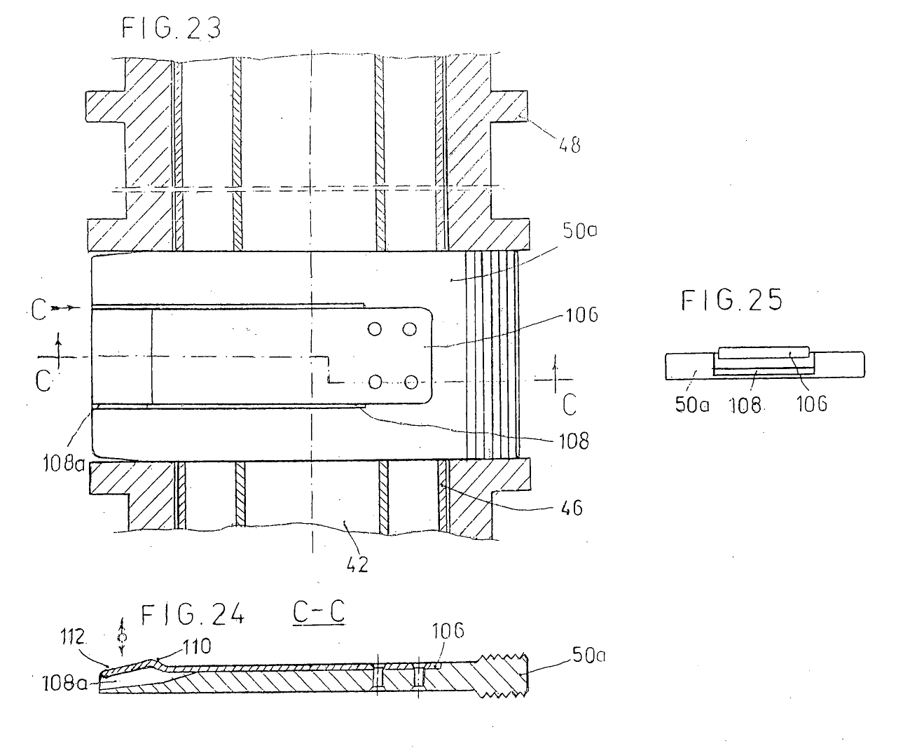

FIGS. 2,3 and 4 show one embodiment of the present invention-multifunction device for home cleaning works. The embodiment of the present invention shown in FIGS. 2,3 and 4 includes the sponge 10 connected with the plate 12. A double-tee bar 14 of which the bottom plate is attached to the plate 12 by rivets or other means, or being an integral part of said plate 12. A top surface of said double-tee bar 14 is a roadway for rolls mounted at the movable stick's connection clip 34. A channel shaped socket 20 is turnably joined with the tubular stick head's 22 protruding section 24 with the axle 26. Two coil springs 28 slid over the axle's 26 ends, Said coil springs 28 ends are pressuring down the socket 20 to the tubular stick head's 22 front face, which is inclined to the axis of the tubular stick 46 about 45°. The slideway 16 which has the shape of the letter T upside down, or of a different shape, is attached to the socket 20 or constitutes an integral part of said socket 20. A slider 18 is a section of the plate 12 with a shape corresponding and facing towards said socket's 20 slideway 16. A locking pawl 30 blocks the plate 12 connected to the sponge 10, or any one of the set tools in work position, slides over the socket's 20 slideway 16. The said looking pawl 30 is slid over the end of one of the coil springs 28, and its tonque 31 enters in the cut 96 as seen in FIGS. 11 and 12, formed on the top surface of the slider 18. The push button-bolt 32 shown in FIG. 10 with a scarf 98 which lifts the locking pawl 30 unlocking the plate's 12 slider 18. The said push button-bolt 32 placed between additional socket's 21 sides with a spring 33. The said socket 21 is placed between sides of the socket 20 and attached to the top surface of the socket 20. The connection clip 34 is the beginning of the movable rod 42 with a set of pressing rolls of a different diameter, the first one the smallest, next one bigger and the next one 36 is the same. The roll 38 and 40 pressing against the socket 20 cause said socket rotation. The clip 34 connected with the movable rod’ 42 or is an integral part of said movable rod 42. A several pairs of guiding semicircular rolls 44 pivotally mounted on both sides of the movable rod 42 which is placed inside the tubular stick 46 with said pressing and guiding rolls 36,38,40 and 44. A pilot sleeve 48 slides over the tubular stick 46 is connected with the movable rod 42 with a pin 50 which is placed across both sides of the pilot sleeve 48 and the pin's 50 slideways 52 formed in the wall of the tubular stick 46, then across the movable rod 42. FIG. 8 shows another slideway 54 formed in the wall of the tubular stick 46 near the tubular stick head 22 for the extension arm's 60 connector 56. Said connector 56 is screwed down to a plate 58 which is attached to the opposite side of the movable rod 42 by rivets or other means, or said plate 58 is an integral part of the movable rod 42. The connector 56 and the movable rod 42, and the plate 58 coupled with each other create this section of the movable rod 42 as a section of a quick-release joint of said extension arm 60 with the movable rod 42. An axle 62 at its middle point of its length is attached to the extension arm's 60 end and binary squeezing rolls 64R and 64L are slid over said axle 62, Two semicircular disks 66 slid over ends of the axle 62 for squeezing out water from edges of the sponge 10 protruding out of the plate 12. A channel 68 formed in the connector's 56 section protrudes outside the tubular stick 46, parallel to said tubular stick 46. Two cylindrical bolts 70 seated across said connector 56 in sides of said channel 68 spaced at a distance from each other. A slat 72 is the ending of the extension arm 60, opposite to its other end with squeezing binary rolls 64R and 64L. Two cuts 74a and 74b formed in said slat 72, sliding over the connector's 56 bolts 70. Due to the wedge shape of cuts 74a and 74b the extension arm 60 jams on said bolts 70. A locking mechanism blocks the extension arm 60 in jammed position. Said looking mechanism comprises two cylindrical bolts 76 connected with each other with a connecting link 78. Said connecting link 78 is provided with an inclined lip 80 overlapping a cut's 84 edge 82 which is inclined the same as said lip 80. Two coil springs 86 slid over said bolts 76 actuating said locking mechanism, thereby the lip 80 overlaps the edge 82 of the cut 84 holding the extension arm 60 in a stable and jammed position. Said bolts 76 placed in holes formed across the connector 56, and the movable rod 42, and the plate 58 create a joint of said bolts 76 with the movable rod 42. A limiter attached to the connector 56 (not shown on the drawings) prevents the locking mechanism sliding off after disconnecting the extension arm 60 from the movable rod 42. Said movable rod 42 with pressing and guiding rolls 36,38,40 and 44. The pilot sleeve 48, and the extension arm 60 with the binary rolls 64R and 64L, and semicircular disks 66 are indispensable, when the sponge mop is in use, but not necessary for other of the set tools, and the extension arm 60 may be taken off. FIG. 8 shows also one of the guiding rolls 44. FIG. 1 shows the general view of the present invention with the sponge mop 10 put to use, and with partially longitudinal cross section showing the connection clip 34 with one of the pressing rolls 40, and the movable rod 42 with the one pair of the semicircular guiding rolls 44. FIG. 5 shows the present invention after passing and squeezing water out of circular disks 66. The socket 20 turned by pressing rolls of different diameter one by one 36,38, and 40 until reaching by said socket 20 of parallel position to the tubular stick 46, the connection clip 34 with said above rolls 36,38 and 40 extending from said tubular stick 46. FIG. 6 shows the device in a side view with the socket 20 turnably connected with the protruding section 24 of the tubular stick 46 head 22 by the axle 26, the slideway 16 of the socket 20, the slider 18 of the plate 12 and the double-tee bar 14 of which top surface is the roadway for the pressing rolls of the movable rod 42. FIG. 7 shows the quick-release joint in details, connecting any of the set tools except the sponge mop with the socket 20 by the slider 88 provided with a pin 90 entering into hole 92 in the tubular stick's 46 head 22 preventing accidental rotation of the socket 20 while using said tool. FIGS. 9 and 10 show in a cross sectional view the details of the present invention putting to use the sponge mop 10 connected with the plate 12. FIGS. 9 and 10 also show the double-tee bar 14 placed on the plate 12 or being its integral part, of which top surface is pressed down by pressing rolls 36,38 and 40 which are mounted at the connection clip's 34 end causing rotation of the socket 20. The protruding sections 24 of the tubular stick head 22 for lacing on them the socket 20 with its sides turnably connected with the tubular stick head 22 by the axle 26. Two coil springs 28 are slid over ends of said axle 26 located within passages of the axle 26 ends formed in the protruding section 24 of the tubular stick head 22; the locking pawl 30 slid over one of ends of said coil spring 28, a tonque 31 of the locking pawl 30 enters into the slider's 18 or 88 cut 96 which is shown in FIGS. 12 and 14. Said locking pawl 30 with its tonque 31 being constantly under pressure of the coil spring 28 end blocks the tool put in, in position, when it is connected with the socket 20. The push button bolt 32 with the scarf 98 lifting the locking pawl 30, the end of which is resting on said scarf 98, unblocking the slider 18 (or 88) of used tool when the push button bolt 32 is pressed by fingers compressing the spring 33 which is slid over said push button bolt 32. Said push button bolt 32 is seated in and through sides of the channel shaped socket 20 and the same shaped additional socket 21, which is attached to the socket 20 or being of said socket 20 integral part. Said coil spring 33 is slid over the push button bolt 32 and holds push button bolt 32 in extreme outside of the socket 20, when the locking pawl 30 end is resting on the lowest point of the push button bolt 32 scarf 98 thereby the locking pawl's tongue 31 is resting in the slider's 18 or 88 cut 96 holding the tool put to use, is coupled with the socket 20 position shown in FIG. 11. FIG. 12 shows the side view of the slider 18 left side with the locking pawl's 30 tonque 31 resting in the slider's 18 (or 88) cut 96, and a scarf 94 at the beginning of the slider 18, enabling automatically lifting the locking pawl 30 while sliding the tool slider 18 over the socket slideway 16. FIG. 13 shows an overhead, view of the locking pawl 30 resting on the scarf 98 of the push button bolt 32, simultaneously the tongue 31 is resting in the cut 96 of the slider 18. FIG. 14 shows the overhead view of the slider 18 with the cut 96 which is formed on the left side of the slider 18, and the same on the slider 88. FIG. 15 shows a front view of a few details of the present invention including the double-tee bar 14, the slider 18 with the cut 96, the plate 12 with one of two bent edges 13a of the plate 12 stiffening said plate 12 connected with the sponge 10. FIG. 16 shows an overhead view of the details shown in FIG. 15 and numerous holes 100 in the plate 12 increasing effectiveness of squeezing out water from the sponge 10 and both bent edges 13a and 13b of the plate 12. FIG. 17 shows the side view of the details shown in FIGS. 15 and 16. FIG. 18 shows the present invention arm attached to the movable rod 42 with applied the permanent joint using a modified extension arm 60 and the same slightly modified connector 56 marked after modification 60a and 56a, enabling permanent joint of one with another. The extension arm's 60a root is slid over the connector 56a and connected by use of rivets, screws or any other manner. FIG. 19 shows the socket 20, marked 20a after slight modification which enables to apply the permanent joint to connect said socket 20a with tubular stick head 22a using screws 102, rivets or other method. The solid fixed connection of the socket. 20a to the tubular stick 46 without using any tubular stick head. The socket 20a is provided with all details like socket 20, the difference only is that one circuit spring 28a is in use instead of two circuit springs 28, One end of said spring 28a constantly presses the locking pawl 30 and its other end rests on the protrusion 104 which is an integral part of the socket 20a. FIG. 20 shows the present invention in side view with the sweep brush X, which is put to use with the application of the angle bar slider 88 provided with the pin 90 located in the hole 92 (see FIG. 7) formed in the tubular stick head 22. In the case of using two independent tubular sticks said pin 90 and the hole 92 are dispensable. FIG. 21 shows the present invention's front view with the paint roller Z put to use, and FIG. 22 shows the side view of the present invention shown in FIG. 21. FIG. 23 shows the overhead view of the modified pin. The flat spring 106 is attached to its plate 50a with one of its ends. Said spring is placed in suitably formed hollow 108 made in said plate. The depth of said hollow is equal to the thickness of the spring 106. The opposite end 110 of said spring towards its end attached to the plate 50a is formed by bending it in order to project beyond the flat plate of the spring 106. A distal ending 112 of said end of said spring is formed into a wedge shape. Said bent end 110 of the spring 106 is hooking up onto the edge of the pilot sleeve's 48 slot, maintaining the modified pin in position. A deepened part 108a of the hollow 108 made in the plate 50a is formed underneath of said bending end 110 of the spring 106. This enables said bent end 110 of the spring 106 to enter said deepened part 108a of the hollow 108 while sliding the modified pin through the slots of the pilot sleeve 48 and the movable rod 42 as well as through the slideways 52 made in the wall of the tubular stick 46.

### Operation of the Multifunction Device Means for Home Cleaning Works

The present invention-multifunction device for cleaning any room, comprises basic parts and exchangeable means being a set of tools for cleaning works, and a detachable extension arm which is indispensable, when a sponge mop is put into use. Said extension arm with a binary roll squeezing out water from said sponge and two semicircular disks at the binary roll's ends squeezing out water from the sponge's edges extending out of a plate connected with the sponge. An operation when a sponge mop is in use, the plate 12 connected with the sponge 10 and the slider 18 of the plate 12 is slid over the slideway 16 of the socket 20. While pushing the plate 12 with its slider 18, the scarf 94 formed at the slider 18 beginning edge lifts the locking pawl 30, then when the sliding operation is over, the locking pawl 30 is automatically falls onto the lowest point of the push button-bolt's 32 scarf 98 being under constant pressure of the end of the coil spring 28, on which the locking pawl 30 is slid. Simultaneously the tongue 31 of the locking pawl 30 falls into cut 96 formed on the top surface of the slider 18, in effect the plate 12 with the sponge 10 is blocked in the working position, and in the same manner is blocked every one tool being in use. By applying pressure to the push button-bolt 32, which is seated between sides of the additional socket 21, the push button-bolt 32 compresses the spring 33 which is slid over said push button bolt 32. In effect the scarf 98 of the push button 32 lifts the locking pawl 30 thereby lifts the tongue 31 of the locking pawl 30, and the plate 12 with the sponge 10, or any other tool being in use is unblocked and may be slid off. The extension arm 60 with the binary squeezing roll 64 and two semicircular squeezing disks 66 are slid over bolts 70 of the connector 56 with wedge cuts 74a and 74b of the extension arm slat 72 which causes jamming of said extension arm on said bolts 70. Due to the first place the extension arm 60 is sliding in perpendicular direction to the axis of the tubular stick 46 then parallel, but previously the connection link 78 of the locking mechanism must be pressed down compressing coil springs 86 which are slid over the locking mechanism's bolts 76 enabling to the cut's 84 inclined edge 82 to pass connection link's 78 lip 80. By releasing pressure applied to the connection link 78 after jamming the slat 72 on bolts 76, its inclined lip 80 automatically overlaps the same inclined edge 82 of the cut 84 actuated by coil springs 86. In effect the extension arm 60 is held in stable and jammed position without any looseness. Contrary operation to the described above is required to disconnect the extension arm 60 from the movable rod 42. By applying pressure to the pilot sleeve 48 said pilot sleeve 48 moves along the tubular stick 46 with the pin 50 which moves along the slideway 52 formed in the tubular stick's wall pushing the movable rod 42 which moves inside the tubular stick 46 with semicircular rolls 44 pivotally attached to both sides of said movable rod 42 rolling on the internal surface of the tubular stick 46 Simultaneously, the rolls 36,38 and 40 mounted at the connection clip 34 which is beginning of the movable rod 42, and one by one starts pressing down the double-tee bar's 14 surface causing rotation of the socket 20 until said socket 20 with the plate 12 and the sponge 10 reach parallel position to the tubular stick 46 axis. Also simultaneously the connector 56 connecting the extension arm 60 with the movable rod 42 moves along the slideway 54 formed in the tubular stick 46 wall near the head 22 of said tubular stick 46. While described above movement of the movable rod 42 with the extension arm 60 and the binary roll 64R and 64L and semicircular disks 66 at the end of the extension arm 60, rolling on the sponge 10 squeeze water out from said sponge 10 and from edges of said sponge 10. While moving back the squeezing out of water is repeated. These numerous holes 100 in the plate 12 increase the efectiveness of said squeezing out of water, and in this manner water is squeezed out in every direction. Every one of the set's tool except the sponge mop 10 is provided with the angle bar slider 88 with the pin 90 entering into hole 92 formed in the head 22 of the tubular stick 46 preventing accidental rotation of the socket 20. In the case of using two independent tubular sticks 46, the quick-release joint, connecting the extension arm 60 with the movable rod 42 is dispensable. A slighty modified extension arm 60 (marked 60a) is attached to the rod 42 by application of the permanent joint. The other tubular stick destined for operation with the other tools excluding the sponge mop, is provided with no movable parts, and thereby with all slideways formed in the wall of the tubular stick 46 are dispensable. The socket 20a is provided with all details indispensable for attaching onto it all other said tools excluding the sponge mop, and with the use of the single circular spring 28a, which constantly presses the locking pawl 30. Said socket 20a is attached to the tubular stick head 22a by application of the permanent joint using, for example, screws 102, rivets or any other method. The modified pin allows the user of the present invention to take out all the movable means while it is used with a set of a variety of tools excluding the sponge mop. The thickened knurled end of said modified pin is embraced by fingers. The applied pressure to it causes the modified pin to slide through the slot of the pilot sleeve 48 and the slot of the movable rod 42 as well as through the slideways 52 in the wall of the tubular stick 46. While said sliding of bent end 110 of the spring 106 it enters the deepened part 108a of the hollow 108 and immediately after exiting of said bend end 110 of the spring 106 hooks up on the edge of the pilot sleeve 48 slot. Contrary operation to the one described above begins with applying pressure on the wedge distal ending 112 of the spring 106. Said pressure causes bending of the spring 106 and thus entering the bent end 110 of said spring 106 into deepened part 108a of the hollow 108. Then pushing on said end 110 of the spring 106 embracing and pulling the knurled end of the plate 50a causes the modified pin to exit the slots of the pilot sleeve 48 and the movable rod 42 thereby exiting the slideways 52 of the tubular stick 46. Said operation allows taking the movable means out of the tubular stick 46. The disconnecting of the sponge together with the sleeves from their plate is done by disconnecting their ends which are connected using the velcro.

What is claimed is:

1. A multifunction device of means for home cleaning works using a variety exchangeable means for a variety of cleaning works comprising:
a tubular stick with a tube stick head of which the front face is inclined to the tubular stick axis at about 45°, and turnably joins the socket to said tubular stick's head; said socket is provided with a slideway for sliding over every one of said means according to which one of them is required to be in use.
a movable rod located inside the tubular stick and connected with a pilot sleeve which is slid over said tubular stick by a pin seated across said movable rod and said pilot sleeve which move together with said rod and said pin along slideways formed in the wall of the tubular stick, actuated by hand; several pressing rolls pivotally mounted at the movable rod's beginning which is formed as a connection clip for said pressing rolls seated with their pivots between and in said connection clip arms, pressing down the socket while moving of the movable rod causing rotation of said socket together with a plate connected with the sponge and slid over the slideway of the socket using the slider of the plate; said rotation until the moment of reaching by said socket with the plate and sponge of a parallel position to the axis of the tubular stick and then it is blocked by a locking means in said position which allows a binary roll to roll over the sponge squeezing water out.
an extension arm with the binary squeezing roll and two semicircular squeezing disks turnably seated at ends of the binary roll axle which is attached to the extension arm's end, and said extension arm is connected with the movable rod by using a quick-release joint, several pairs of guiding rolls pivotally mounted on both sides of the movable rod rolling along internal surface of the tubular stick move together with said movable rod.
a means blocking said extension arm in working position.
a set of a variety of exchangeable tools, but using one stick only.

2. The multifunction device for home cleaning means according to claim 1 wherein said socket is turnably connected to the tubular stick head by an axle near the tubular stick head's edge and two coil springs slid over said axle's ends constantly pressing with their ends of said socket against the tubular stick head's face.

3. The multifunction device for house cleaning means according to claim 1 wherein said locking means blocking a tool which is slid over the socket's slideway in position ready for work comprises a push button-bolt with a scarf, said button-bolt seated between channel shaped socket's sides with a coil spring slid over said push button-bolt; a locking pawl slid over one of the socket coil spring's end; said locking pawl's tongue enters into a cut on said slider's top surface, and the locking pawl's end simultaneously falling on the push button-bolt's scarf blocking said tool slid over the socket slideway; said push button-bolt's scarf for lifting the locking pawl to unblock the tool while the push button bolt moves being under pressure of one's hand fingers, compressing the spring slid over said push button bolt; a small pin attached to every one of the present invention tool's slider, except the tool with the sponge mop, said pin enters into a hole in the tubular stick head preventing rotation of the socket.

4. The multifunction device for home cleaning means according to claim 1 wherein said movable means causing rotation of the socket comprises a few pressing rolls turnably mounted at the movable rod's beginning which is formed as a connection clip for said pressing rolls, first one of which is the smallest diameter, next and next bigger, placed between said connection clip's arms rolling on and pressing down one by one the socket until said socket with the sponge reaches parallel position to the tubular stick axis.

5. The multifunction device for home cleaning means according to claim 1 wherein the means to move the movable rod placed inside the tubular stick comprises a few pairs of semicircular guiding rolls speed along and on both sides of the movable rod and rolling over the tubular stick integral surface actuated by applying manual pressure to the pilot sleeve connected with the movable rod; said pilot sleeve slid over the tubular stick.

6. The multifunction device for home cleaning means according to claim 1 wherein the means to squeeze water out from the sponge comprises an extension arm with a squeezing binary roll turnably mounted on the axle; said axle attached at its middle point of its lenght to said extension arm's end, and two semicircular squeezing disks mounted at the said axle ends; said axle attached at its middle point of its lenght to said extension arm end, said binary roll squeezing water out from the sponge and said two semicircular disks, squeezing water out from the sponge's edges protrude outside the plate connected with said sponge and numerous holes made in said plate for squeezing water out in result of this, water is squeezed from the sponge in all directions.

7. The multifunction device for home cleaning means according to claim 1 wherein the means for connecting the extension arm with the movable rod by the quick-release joint comprises a channel shaped connector attached to the movable rod by screws entering through said movable rod and screwed into a plate on the other side of the movable rod, said plate is attached to the movable rod by rivets or other means, or is an integral section of said movable rod; two bolts entering across said channel of the connector and seated in its sides spaced along said channel at a distance from each othera slat which constitutes the extension arm's end, opposite to the end with the binary squeezing roll and two wedge shaped cuts formed in said slat; said wedge cuts sliding over said bolts creating said quick-release joint jamming the extension arm on said bolts; the movable rod's connector protrude out of the tubular stick exiting through a slideway formed in the tubular stick wall, near the tubular stick's head enabling connection and moving of said movable rod with the extension arm along the tubular stick.

8. The multifunction device for home cleaning means according to claim 1 wherein said means blocking the extension arm in working position comprises two cylindrical bolts entering through holes made in the connector which is attached to the movable rod and said bolts are connected to each other by a connector link which is provided with an inclined lip overlapping the same inclined edge of a cut as said lip edge, and said cut is formed at the end of the extension arm slat's end; said overlapping is created by constant pressure of coil springs slid over said two bolts.

9. A multifunction device of means for home cleaning using a variety of exchangeable means for a variety of cleaning works comprises plural exchangeable tools used for variable cleaning works, at home, offices, other rooms and gives the possibility for using it for other works comprising tools used for example: for washing floors, windows, for applying wax on floors, painting walls, scratching a surface, cutting off branches of trees or bushes growing too high up to be reached by hand, every one is provided with identical slider, sliding over the slideway of the socket which is attached to the tubular stick's head. While using two tubular sticks instead of one only, the device with the sponge mop is provided with the extension arm, which is attached to the movable rod by application of the permanent joint. The other tubular stick for the other tools is provided with no movable details and the socket slideways onto which said tools are put on, is attached to the tubular stick or to the tubular stick head with use the permanent joint.

10. A multifunction device of means for home cleaning works using a variety of exchangeable means for a variety of cleaning works copmprising:
a modified pin comprises a means for connecting the pilot sleeve slid over the tubular stick, with the movable rod and disconnecting from said movable rod located inside of the said tubular stick, and said means allows to do said operation with one hand movement, a plate with a hollow in which is placed and attached to it a flat spring of the same thickness as the depth of said hollow and an ending of the same spring opposite to the end attached to the plate is formed into the wedge shape which enables sliding said modified pin through the slots of the pilot sleeve and of the movable rod as well as through the slideways of the tubular stick's wall.
a deepened part of the hollow is formed adjacent to the end of the spring, which enables said end of the spring to enter said slots and allows sliding the modified pin through said slots of the pilot sleeve and of the movable rod as well as through the slideways of the tubular stick's wall.
one end of the spring is bent, and with said bending hookes up onto the edge of the pilot sleeve's slot, resulting in maintaning the modified pin in position connecting the pilot sleeve with all movable means inside the tubular stick, using said modified pin which allows the user of said multifunction device to take out all movable means placed inside the tubular stick.

11. A multifunction device of means for home cleaning works using a variety of exchangeable means for a variety of cleaning works comprises:
a sponge connected to its plate by using a velcro which allows to use one tubular stick only without any movable means and with head of said tubular stick provided with the means allowing for exchanging one tool into another one with just one hand movement; a sponge connected to its plate by using the velcro using two sleeves made of rubber tapes or rubber tapes together with ordinary tapes permanently connected to the sponge's plate and said sleeves are created by connecting their ends to each other using said velcro which allows to disconnect the sponge from its plate by hand.
